(19) United States
(12) Patent Application Publication
(10) Pub. No.: US 2024/0088670 A1
(43) Pub. Date: Mar. 14, 2024

(54) INTELLIGENT VOLTAGE LIMIT VIOLATION PREDICTION AND MITIGATION FOR ACTIVE DISTRIBUTION NETWORKS

(71) Applicant: Qatar Foundation for Education, Science and Community Development, Doha (QA)

(72) Inventor: Mohd Zamri Che Wanik, Doha (QA)

(21) Appl. No.: 18/368,168

(22) Filed: Sep. 14, 2023

Related U.S. Application Data
(60) Provisional application No. 63/406,566, filed on Sep. 14, 2022.

(51) Int. Cl. H02J 3/38; H02J 3/00; H02J 13/00

(52) U.S. Cl. CPC H02J 3/381; H02J 3/003; H02J 13/00002; H02J 2300/24

(57) ABSTRACT

Intelligent voltage limit violation prediction and mitigation for active distribution networks may be provided by: measuring, at one or more of a plurality of phasor measurement units (PMUs) connected between a power grid and associated loads, a present power produced by photovoltaic systems deployed downstream from the one or more of the plurality of PMUs; measuring, at the one or more of the plurality of PMUs, a present demand for power from the associated loads; generating a power production prediction by the photovoltaic systems for an upcoming time period; generating a demand prediction for power from the loads for the upcoming time period; and taking a mitigation action based on the power production prediction and the demand prediction indicating a predicted voltage constraint violation in the upcoming time period.

### CROSS-REFERENCES TO RELATED APPLICATIONS

The present disclosure claims the benefit of U.S. Provisional Patent Application No. 63/406,566 entitled “INTELLIGENT VOLTAGE LIMIT VIOLATION PREDICTION FOR ACTIVE DISTRIBUTION NETWORK” and filed on Sep. 14, 2022, which is incorporated herein by reference in its entirety

### TECHNICAL FIELD

The present disclosure relates to the use of a neural network to predictively control distributed energy sources to manage localized and overall power grid health.

### SUMMARY

The present disclosure provides new and innovative systems and methods the use of a neural network to predictively control distributed energy sources to manage localized and overall power grid health. The neural network forecasts disturbances in power grids that include distributed energy sources (such as solar power generators) that are connected to various low and medium voltage points in the power grid. The neural network is provided as a network controller for a distributed power grid that predicts (and preemptively corrects) localized or widespread voltage imbalances in the power grid.

In various aspects, a method, a system for performing the method, and various goods produced by the method are provided. In various aspects, the method includes: training an artificial neural network to predict fluctuations in voltage for a power grid including a plurality of photovoltaic generators; deploying the artificial neural network to generate a prediction for a voltage in the power grid; and adjusting a tap position on a transformer included in the power grid or an injected current from the photovoltaic generator based on the prediction to manage a voltage level in the power grid.

In some aspects, the artificial neural network is trained using the Levenberg-Marquardt backpropagation algorithm.

In various aspects, a method, a system for performing the method, and various goods produced by the method are provided. In various aspects, the method includes: measuring, at one or more of a plurality of phasor measurement units (PMUs) connected between a power grid and associated loads, a present power produced by photovoltaic systems deployed downstream from the one or more of the plurality of PMUs; measuring, at the one or more of the plurality of PMUs, a present demand for power from the associated loads; generating a power production prediction by the photovoltaic systems for an upcoming time period; generating a demand prediction for power from the associated loads for the upcoming time period; and adjusting a tap position on a substation transformer serving the power grid from a generator source to the associated loads based on the power production prediction and the demand prediction indicating a predicted voltage constraint violation in the upcoming time period.

In some aspects, the method further or alternatively comprises in response to detecting the predicted voltage constraint violation in the upcoming time period: injecting reactive power into the power grid from one or more PV systems during the upcoming time period via inverters associated with the one or more PV systems.

In some aspects, an artificial neural network generates the power production prediction and the demand prediction and determines whether the power production prediction and the demand prediction indicate the predicted voltage constraint violation in the upcoming time period.

In some aspects, the artificial neural network is trained using the Levenberg-Marquardt backpropagation algorithm using historical data for power demand and PV generation.

In some aspects, each PMU of the plurality of PMUs is installed at a corresponding junction between medium voltage and low voltage in the power grid.

In some aspects, the substation transformer is installed at a junction between high voltage and medium voltage in the power grid.

In some aspects, the predicted voltage constraint violation is indicated when a voltage drop or rise greater than 5 percent of a nominal voltage limit is predicted to occur in the upcoming time period.

In some aspects, the upcoming time period has a duration of one hour, wherein the present power produced and the present demand are measured during an hour prior to the upcoming time period.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates an example power grid, according to embodiments of the present disclosure.

FIGS. 2A-2C illustrate voltage reduction control schemes via reactive power injection, according to embodiments of the present disclosure.

FIG. 3 illustrates an example, electrical management system, according to embodiments of the present disclosure.

FIG. 4 is a block diagram for operation of an intelligent voltage limit violation prediction and mitigation system, according to embodiments of the present disclosure.

FIG. 5 is a flowchart for an example method of intelligent voltage limit violation prediction and mitigation for active distribution networks, according to embodiments of the present disclosure.

FIG. 6 illustrates a computing device, according to embodiments of the present disclosure.

### DETAILED DESCRIPTION

The present disclosure provides new and innovative systems and methods the use of a neural network to predictively control distributed energy sources to manage localized and overall power grid health. The neural network forecasts disturbances in power grids that include distributed energy sources (such as solar power generators) that are connected to various low and medium voltage points in the power grid. The neural network is provided as a network controller for a distributed power grid that predicts (and preemptively corrects) localized or widespread voltage imbalances in the power grid.

Solar Photovoltaics (PV) have been seen as one of the technologies that can minimize the dependency on conventional fossil fuels, which contribute to greenhouse gas in the environment. The use of PV technology, which will never run out of its energy source (e.g., solar power) ensures the sustainability of the electricity supply offered by PV technology.

Most PV plants are connected to distribution networks, and mainly to the 11 kilovolt (kV) and 0.415 kV levels. It is expected that the penetration level of PV electricity generation will reach 15% of total generation capacity by 2030. Despite assurance that this penetration level is practical, having such a high level of total generation capacity may require various accommodations or management strategies to be put in place to avoid causing the problem in distribution networks. The most highlighted issues that may require management include voltage variations, which in most cases results in a voltage limit violation. The problem arises due to the variation of solar power output and conventional control of voltage in the distribution network. The conventional voltage control scheme is designed for controlling voltage in the passive distribution network, but when generation sources are introduced in the distribution network, the effectiveness of the conventional voltage control scheme can be significantly affected.

Taking advantage of more advanced sensing devices being introduced to the distribution network, such as Phasor measurement units (PMU), with the trend of deploying Artificial Intelligence (AI) as the industry is moving toward Industry 4.0, an intelligent management tool is expected to be useful in monitoring, protecting, and controlling the power distribution networks of the future. Some of the management modules that are expected to be integrated into the management module.

PMUs produce accurate time-stamped magnitude and phasor angle measurements of voltage and current. PMUs may also report the status of breakers with timestamps synchronized to those of the measurements. Because PMUs calculate synchrophasors with respect to a global angle reference, the number of critical measurements is less than when compared to conventional supervisory control and data acquisition (SCADA) measurements. PMU deliver three basic measurements that traditional measurement methods do not, including: an angle measurement and a magnitude measurement of a voltage or current supplied and/or demanded at certain times at a point on the electrical grid where the PMU is deployed.

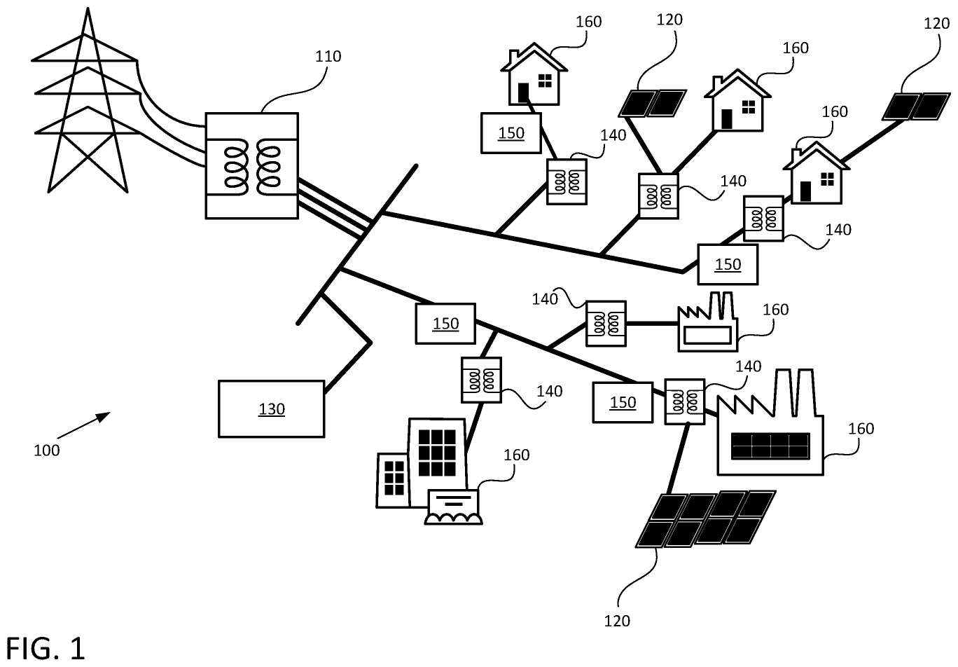

FIG. 1 illustrates an example power grid 100 or distribution network, according to embodiments of the present disclosure. A conventional distribution network is typically designed and operated without considering any generation inside it. The voltage within the network is controlled through the conventional methods where, during the normal operations, the voltage limit is maintained according to the limit imposed by a power grid operator. Normal operations is defined as when all major elements including lines, cables, and transformers are in operation. However, when one or more of the major elements are not operating due to a forced or scheduled outage, the power grid 100 may instead be said to be operating in a contingency operating condition.

Typically, main voltage control in a distribution system is provided by on-load tap changing (OLTC) transformers 110 at large substations (also referred to as substation transformers). For example, the tap position for the 11/0.415 kV transformer is adjusted during the planning stage so that voltage will be in the permitted range during low and high load; thereby performing voltage control in the power grid 100. In any situation where the tap position needs to be readjusted, the transformer 110 has to be disconnected from the supply on the high voltage side. These situations may arise if the voltage is outside the bandwidth for more than a threshold period of time (e.g., ninety seconds), after which a command is sent to the tap changer to change its tap position. This tap changing operation is performed within a short period of time (e.g., three to ten seconds). In practice, the total operation time of the OLTC voltage control scheme is therefore approximately 100 seconds from initial voltage violation to resolution. This process is repeated from time to time continuously throughout the operation of the power grid 100. In addition to OLTC transformers 110, switched and fixed battery/capacitor banks 130 are sometimes employed at strategic locations within the power grid 100 to help ride-through voltage spikes or dips.

The voltage profile of the power grid 100 varies with load demand and follows human activities according to the time of the day and season of the year. For example, peak load in the winter season nearly doubles the peak load in fall. Various load sources 160 may include residential or commercial offerings, with distinct demand cycles. During light load, the voltage rises and in contrast decreases during heavy load condition unless a voltage control scheme keeps the voltage within a voltage constraint following the changes in load demand. A voltage control scheme works conventionally based on the local measurement at a distribution transformer, and is usually operated independently.

However, as PV systems 120 are often deployed downstream from the OLTC transformers 110 and distribution transformers 140, and may be deployed on different voltage levels throughout the power grid 100, the power input to the power grid is outside of the control of the grid operator, and may affect how the taps at the OLTC transformers 110 are selected to maintain voltage within the voltage constraint. Additionally, the fact that fluctuations in irradiance occur throughout the day due to changes in irradiance (e.g., cloud overage, shifting shadows, etc.), these sudden changes in irradiance are expected to directly impact the power output generated by the PV system 120, which induces fluctuations of the voltage over the distribution transformer 110 where the PV system 120 is connected.

The prediction on the voltage violation can be used to coordinate control the PV system 120 to inject reactive power to regulate the voltage in the power grid 100. Modern PV inverters, such as ones that employ decoupled power control, have the capability to inject reactive power when given the reactive power reference. The reactive power reference can be set locally or sent remotely via a communication medium by providing the correspondent voltage reference. The reactive power to be injected follows the reactive power characteristic programmed to the inverter.

Future distribution networks will be challenging to manage due to the integration of small distributed energy resources (DER) units such as PV systems 120 into their medium and low voltage levels. One of the technical issues regards the voltage, especially in the proximity of the DER units to the loads. Additionally, DER units create additional challenges in operating the grid 100, due to a bidirectional power flow that may result from the misperception of the grid operator for how the operator views load vs generation downstream form the distribution transformer. For example, the grid operator may interpret the increase of DER output as a reduction in load.

To counter this misinformation, PMUs 150 are deployed at strategic positons in the grid, such as at junctions between medium and low voltage portions of the grid upstream or downstream of the associated distribution transformers 140, to allow for active management of the grid 100. The active management of the grid 100 provides network development and operational solutions to these challenges through a variety of means including structured off-line and real-time information exchange, increased monitoring, simulation, and control via information and telecommunication technologies.

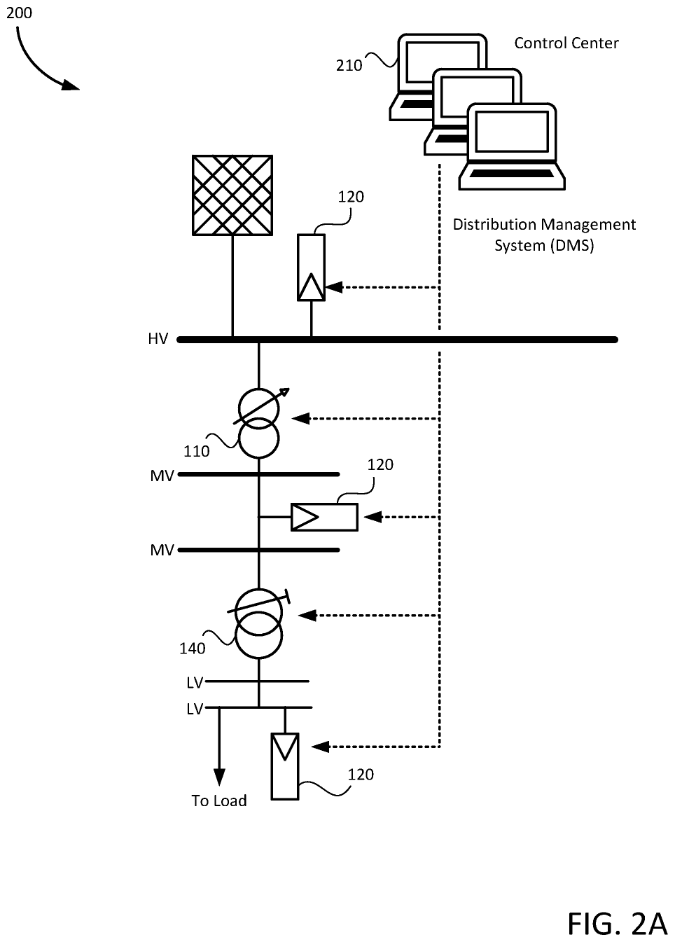

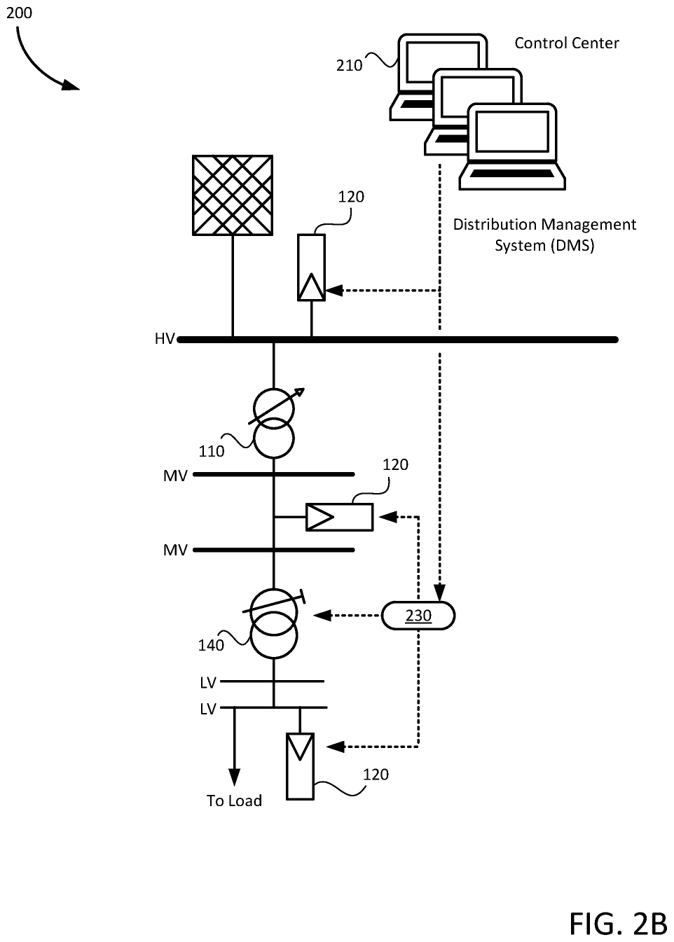

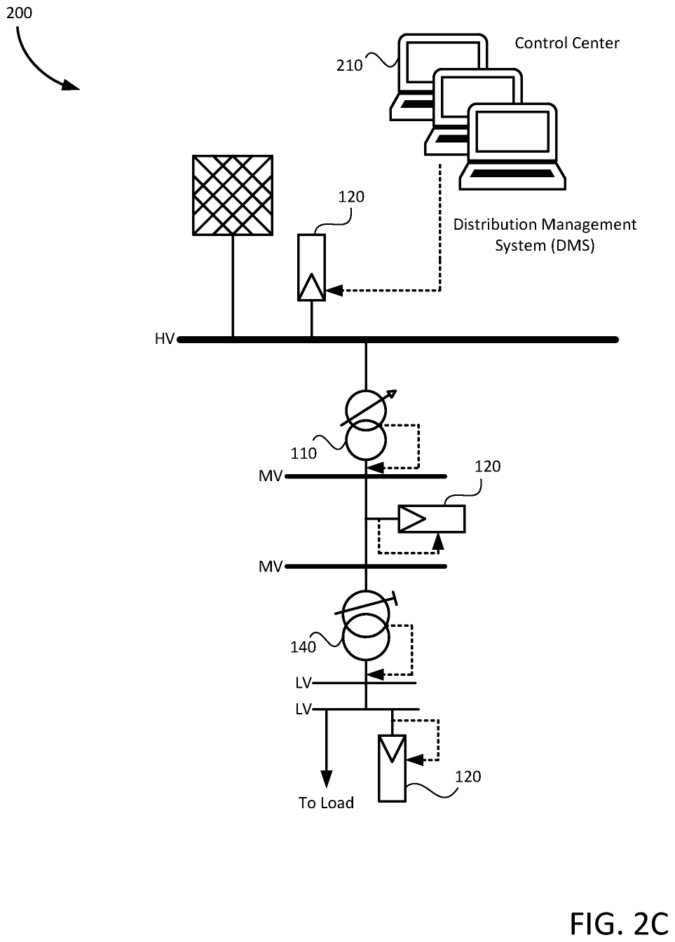

FIGS. 2A-2C illustrate voltage reduction control schemes 200 via reactive power injection, according to embodiments of the present disclosure. For ease of reference, the control signals are indicated via dashed lines, whereas power cables are indicated via solid lines.

In the centralized control scheme 200 shown in FIG. 2A, all PV monitoring and control is performed remotely by a central management system or control center 210. For example, voltage control is coordinated across PV systems 120 and other devices.

In the decentralized control scheme 200 shown in FIG. 2B, there are two types of control: master and slave. A micro DMS 220 is located close to where the PV systems 120 are connected. This micro DMS 220 monitors and coordinates the PV system 120 and local voltage control devices locally after receiving a command from central control 210. Here, there is no direct communication between PV systems 120 connected to medium or low voltage and central control 210, although the central control 210 may be in communication with PV systems 120 connected to high voltage.

In the localized control scheme 200 shown in FIG. 2C, there is no coordinated control between the PV system 120 and other voltage control devices; the voltage control of PV system 120 and other devices is set individually without coordination.

In various embodiments, a neural network is trained for deployment to the various controlling devices based on the selected control scheme 210-230.

In various embodiments, a neural network is trained using the Levenberg-Marquardt backpropagation algorithm. Training is set to automatically stop when generalization stops improving, as indicated by an increase in the mean square error (MSE) of the validation samples. Training multiple times will generate different results due to different initial conditions and sampling. MSE is the average squared difference between outputs and targets. Lower values are better with zero means no error. Regression (R), values measure the correlation between outputs and targets. An R-value of 1 means a close relationship, 0 a random relationship.

The performance of the predictive algorithm in predicting shows that the accuracy of the algorithm in predicting the voltage during the training, test and validation. The results show that the predictive algorithm is able to make a prediction with very high accuracy.

An intelligent predictive technique for forecasting the voltage violation limit in the distribution network which has a number of PV sources is presented. The technique employs a neural network for forecasting the potential voltage violation. The effectiveness of the method is tested with the case study on the real network and the result is promising. The results show that the predictive algorithm is able to make a prediction with very high accuracy. The highest error is 0.005 p.u. which is less than 1%. An intelligent predictive technique is suitable to be integrated into an active distribution network management scheme for the distribution network.

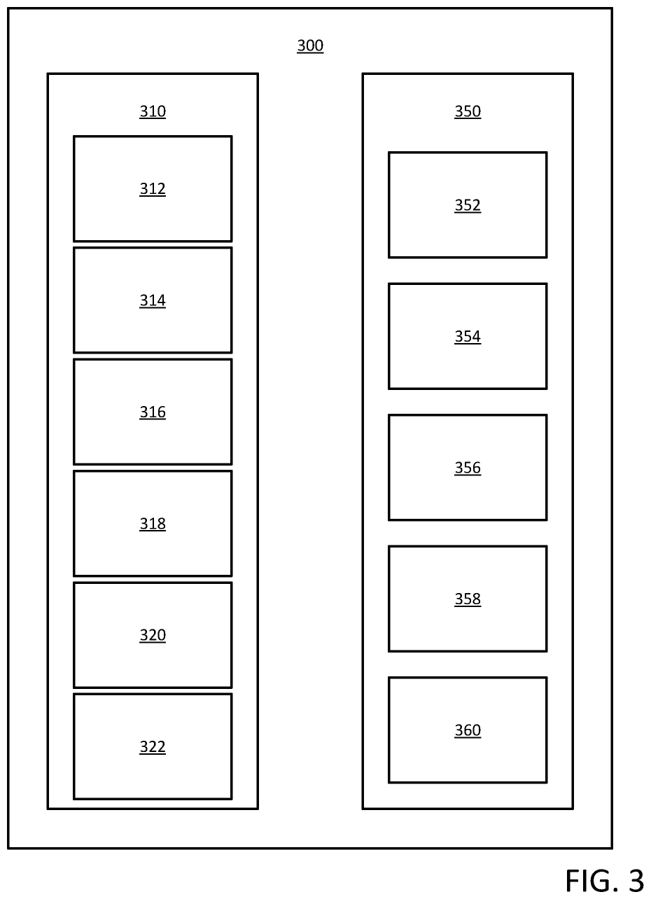

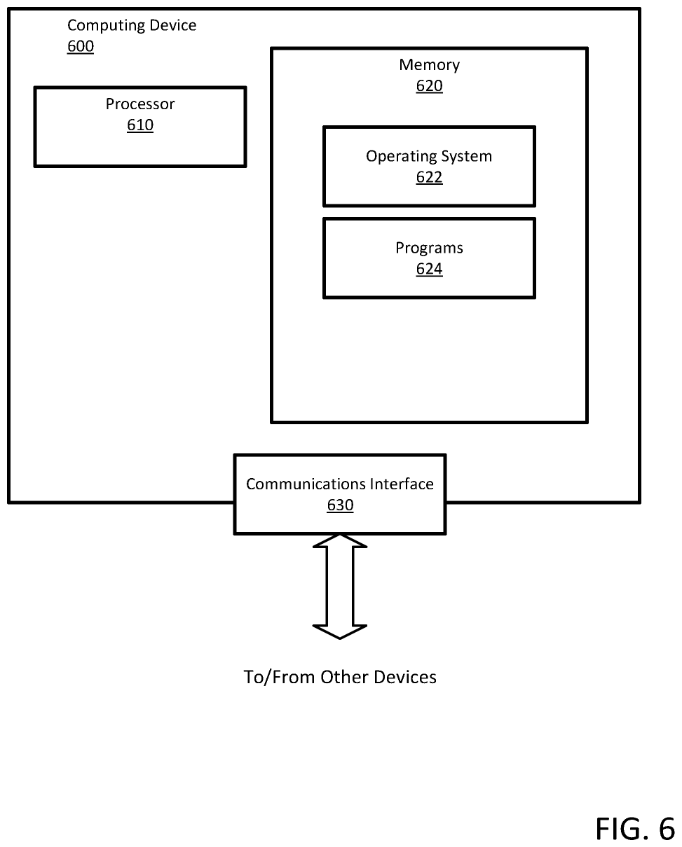

FIG. 3 illustrates an example, electrical management system 300, according to embodiments of the present disclosure. The system 300 may be implemented on one or more computing devices 600, as described in relation to FIG. 6. The system 300 includes a real time monitoring application 310 and a real time control and protection application 350.

The real time monitoring application 310 includes real time dynamic visualization displays 312, real time phasor monitoring systems 314, PV monitoring systems 316, battery/capacitor bank monitoring systems 318, power and load flow monitoring systems 320, and historical data analysis tool systems 322.

The real time control and protection application 350 includes a coordinated voltage control system 352, a systematic load shedding system 354, a smart and efficient demand responses system 356, an intelligent protection scheme and fault management system 358, and an autonomous power system simulation in the loop system 360 (e.g., a software tool for PV integration).

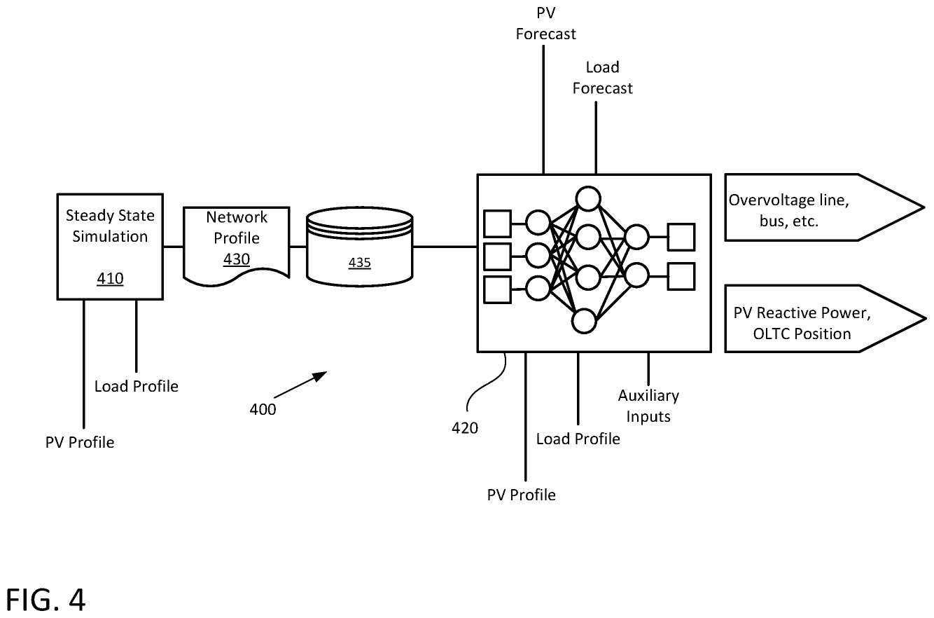

FIG. 4 is a block diagram for operation of an intelligent voltage limit violation prediction and mitigation system 400, according to embodiments of the present disclosure. The system 400 may be implemented on one or more computing devices 600, as described in relation to FIG. 6.

A steady state simulation 410 acts as a digital twin of the power grid that an ANN 420 is being trained to model is provided that produces a simulated network profile 430, which may be collected with other network profiles in a database 435. The network profile(s) 430 is/are fed into the ANN 420 along with predicted PV power production and a predicted power demand for the loads. The ANN 420 is trained to output one or more of the transformer tap position for an OLTC transformer and a PV reactive power setpoint for the grid, and outputs predictions for which line, bus, or node in the grid is expected to experience the voltage violation. Accordingly, the PV reactive power and/or OTLC tap position, may be transmitted to one or more operators or control devices in the power grid to make appropriate adjustments thereto (e.g., as control signals).

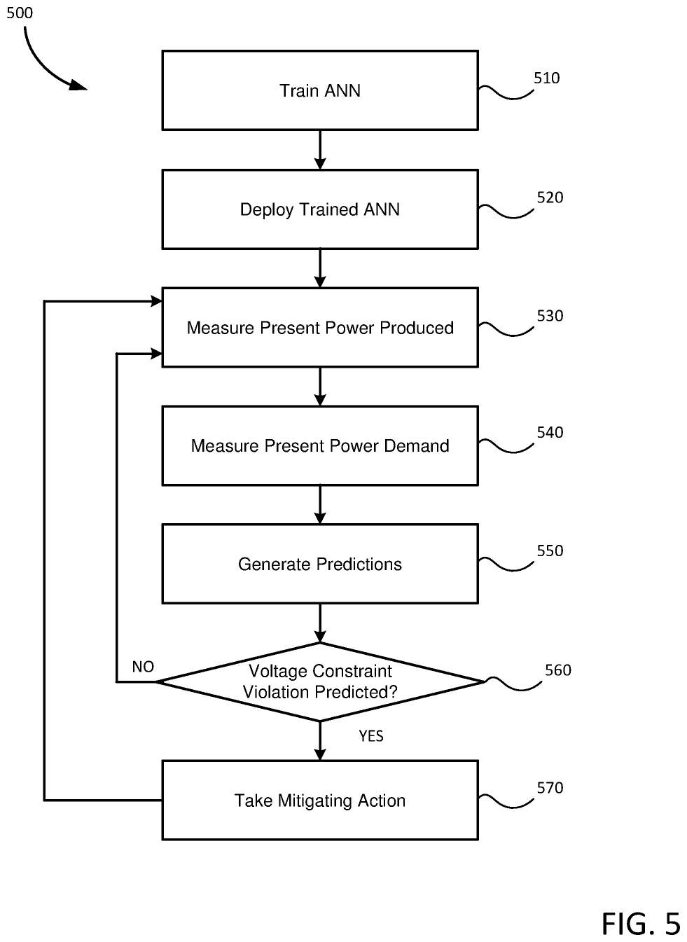

FIG. 5 is a flowchart for an example method 500 of intelligent voltage limit violation prediction and mitigation for active distribution networks, according to embodiments of the present disclosure. Method 500 may begin with block 510, where an artificial neural network (ANN) is trained based on historical data for power demand and irradiance or other PV generation capability information. Depending on the selected control scheme (centralized, decentralized, or localized), the ANN is trained based on the data provided to the controlling computing device(s) and actions available for those controlling computing devices to signal to devices under their control. In some embodiments, the ANN is trained to generate the power production predictions for the localized PV systems and a demand prediction for various loads and to determine whether the power production prediction and the demand prediction indicate the predicted voltage constraint violation in an upcoming time period. In some embodiments, the ANN is trained using the Levenberg-Marquardt backpropagation algorithm using historical data for power demand and PV generation.

At block 520, the ANN is deployed to the various control devices for the selected control scheme. The deployed ANN acts as a digital twin to the actual power grid managed by the ANN; using a rolling window of data to predict future operations of the power grid (e.g., power generation capacity, power demand) in upcoming time periods. For example, a day may be divided into hourly time periods, where the ANN uses operational data from a current time period to predict the power production level and power demand level in the next time period. In various embodiments, the predictions may include data from more than one time period (e.g., the current hour h₀ and the prior n hours h₀₋₁, h₀₋₂, . . . h₀₋ₙ) used to predict the immediately subsequent time period's operational conditions (h₁) or the next n hours (e.g., h₁, h₂, . . . hₙ) and determine when the predictions indicate an upcoming voltage constraint violation in the future so that appropriate mitigating actions can be taken.

At block 530, one or more of a plurality of phasor measurement units (PMUs) connected between a power grid and associated loads measure a present power produced by PV systems deployed downstream from the one or more of the plurality of PMUs. These data are then transmitted to a control unit, which may vary based on the selected control scheme. Transmissions may be sent over the power lines, over separate wired transmission media, or wirelessly in various embodiments.

At block 540, one or more of the plurality of PMUs measure a present demand for power from the associated loads. These data are then transmitted to a control unit, which may vary based on the selected control scheme. Transmissions may be sent over the power lines, over separate wired transmission media, or wirelessly in various embodiments.

In various embodiments, the PMUs used to measure the present power demand (per block 540) include the PMUs used to measure the current power produced by the PV systems (per block 530) and may include one or more PMUs that are not associated with any PV systems. The various PMUs of the plurality of PMUs may each be installed at a corresponding junction between medium voltage and low voltage in the power grid, either upstream or downstream of a distribution transformer, or at other nodes to monitor multiple distribution transformers or the combined inputs/outputs to the grids for several loads or PV systems.

At block 550, using the received data (per block 530 and block 540) for the current operating conditions, the ANN generates a power production prediction for the PV systems for an upcoming time period and a demand prediction for power from the load for the upcoming time period.

At block 560, the ANN determines whether the predicted values for the upcoming time period indicate a predicted voltage constraint violation in the upcoming time period within a confidence interval. In various embodiments, the ANN may use different thresholds for variances from a nominal voltage value to signify that the data indicate a predicted violation of the voltage constraint. For example, a voltage drop or rise greater than 5 percent of a nominal voltage limit may be used as a threshold, but other values are also contemplated.

When the predicted values do not indicate a predicted voltage constraint violation, method 500 may return to block 530 to continue monitoring the power grid. When the predicted values do indicate a predicted voltage constraint violation, method 500 proceeds to block 570 to take a mitigating action.

At block 570, the ANN signals for one or more mitigating actions to be taken to mitigate or prevent the predicted voltage constraint violation. In some embodiments, the mitigating action includes adjusting a tap position on a substation transformer serving the power grid (e.g., from a generator source or high voltage transmission source—installed at a junction between high voltage and medium voltage in the power grid) to the associated loads based on the power production prediction and the demand prediction indicating. In some embodiments, the mitigating action includes injecting reactive power into the power grid from one or more PV systems during the upcoming time period via inverters associated with the one or more PV systems. In some embodiments, the mitigating action could include starting, stopping, or shifting power generation on the high voltage side of the power grid (e.g., idling or starting centralized power production, charging or discharging centrally managed batteries, load/power shifting between medium voltage sub-networks). Method 500 may then return to block 530 to continue monitoring the power grid.

FIG. 6 illustrates a computing device 600, as may be used in the PMUs, control stations, and other devices with smart capabilities, according to embodiments of the present disclosure. The computing device 600 may include at least one processor 610, a memory 620, and a communication interface 630.

The processor 610 may be any processing unit capable of performing the operations and procedures described in the present disclosure. In various embodiments, the processor 610 can represent a single processor, multiple processors, a processor with multiple cores, and combinations thereof.

The memory 620 is an apparatus that may be either volatile or non-volatile memory and may include RAM, flash, cache, disk drives, and other computer readable memory storage devices. Although shown as a single entity, the memory 620 may be divided into different memory storage elements such as RAM and one or more hard disk drives. As used herein, the memory 620 is an example of a device that includes computer-readable storage media, and is not to be interpreted as transmission media or signals per se.

As shown, the memory 620 includes various instructions that are executable by the processor 610 to provide an operating system 622 to manage various features of the computing device 600 and one or more programs 624 to provide various functionalities to users of the computing device 600, which include one or more of the features and functionalities described in the present disclosure. One of ordinary skill in the relevant art will recognize that different approaches can be taken in selecting or designing a program 624 to perform the operations described herein, including choice of programming language, the operating system 622 used by the computing device 600, and the architecture of the processor 610 and memory 620. Accordingly, the person of ordinary skill in the relevant art will be able to select or design an appropriate program 624 based on the details provided in the present disclosure.

The communication interface 630 facilitates communications between the computing device 600 and other devices, which may also be computing devices as described in relation to FIG. 6. In various embodiments, the communication interface 630 includes antennas for wireless communications and various wired communication ports. The computing device 600 may also include or be in communication, via the communication interface 630, one or more input devices (e.g., a keyboard, mouse, pen, touch input device, etc.) and one or more output devices (e.g., a display, speakers, a printer, etc.).

Although not explicitly shown in FIG. 6, it should be recognized that the computing device 600 may be connected to one or more public and/or private networks via appropriate network connections via the communication interface 630. It will also be recognized that software instructions may also be loaded into the memory 620 (as an example of a non-transitory computer readable medium) from an appropriate storage medium or via wired or wireless means.

Accordingly, the computing device 600 is an example of a system that includes a processor 610 and a memory 620 that includes instructions that (when executed by the processor 610) perform various embodiments of the present disclosure. Similarly, the memory 620 is an apparatus that includes instructions that when executed by a processor 610 perform various embodiments of the present disclosure.

Certain terms are used throughout the description and claims to refer to particular features or components. As one skilled in the art will appreciate, different persons may refer to the same feature or component by different names. This document does not intend to distinguish between components or features that differ in name but not function.

As used herein, the term “optimize” and variations thereof, is used in a sense understood by data scientists to refer to actions taken for continual improvement of a system relative to a goal. An optimized value will be understood to represent “near-best” value for a given reward framework, which may oscillate around a local maximum or a global maximum for a “best” value or set of values, which may change as the goal changes or as input conditions change. Accordingly, an optimal solution for a first goal at a given time may be suboptimal for a second goal at that time or suboptimal for the first goal at a later time.

As used herein, the terms “upstream” and “downstream” are understood to refer to relative positions of elements arranged in series in a power distribution network from a high voltage to low voltage, where elements connected closer to or to a higher voltage are considered to upstream to elements connected further from higher voltages or to lower voltage. For example, a first element connected in series “upstream” to a second element is closer to a higher voltage connection than the second element, and may be connected to medium or high voltage when the second element is connected to low voltage, or connected to high voltage when the second element is connected to medium or low voltage. The second element in the preceding example may also be referred to as being “downstream” to the first element.

As used herein, the terms “low voltage”, “medium voltage”, and “high voltage” are used as terms of the art, which will be understood to vary in the definitions of what voltage values fall therein in various jurisdictions and power distribution schemes. One of ordinary skill in the art will be familiar with these definitions, and will be able to apply the corresponding definitions in the appropriate jurisdiction without difficulty or misunderstanding.

Various units of measure may be used herein, which are referred to by associated short forms as set by the International System of Units (SI), which one of ordinary skill in the relevant art will be familiar with.

As used herein, “about,” “approximately” and “substantially” are understood to refer to numbers in a range of the referenced number, for example the range of −10% to +10% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole numbers, or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in the present disclosure, a phrase referring to “at least one of” a list of items refers to any set of those items, including sets with a single member, and every potential combination thereof. For example, when referencing “at least one of A, B, or C” or “at least one of A, B, and C”, the phrase is intended to cover the sets of: A, B, C, A-B, B-C, and A-B-C, where the sets may include one or multiple instances of a given member (e.g., A-A, A-A-A, A-A-B, A-A-B-B-C-C-C, etc.) and any ordering thereof. For avoidance of doubt, the phrase “at least one of A, B, and C” shall not be interpreted to mean “at least one of A, at least one of B, and at least one of C”.

As used in the present disclosure, the term “determining” encompasses a variety of actions that may include calculating, computing, processing, deriving, investigating, looking up (e.g., via a table, database, or other data structure), ascertaining, receiving (e.g., receiving information), accessing (e.g., accessing data in a memory), retrieving, resolving, selecting, choosing, establishing, and the like.

Without further elaboration, it is believed that one skilled in the art can use the preceding description to use the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

Within the claims, reference to an element in the singular is not intended to mean “one and only one” unless specifically stated as such, but rather as “one or more” or “at least one”. Unless specifically stated otherwise, the term “some” refers to one or more. No claim element is to be construed under the provision of 35 U.S.C. § 112(f) unless the element is expressly recited using the phrase “means for” or “step for”. All structural and functional equivalents to the elements of the various embodiments described in the present disclosure that are known or come later to be known to those of ordinary skill in the relevant art are expressly incorporated herein by reference and are intended to be encompassed by the claims. Moreover, nothing disclosed in the present disclosure is intended to be dedicated to the public regardless of whether such disclosure is explicitly recited in the claims.

What is claimed is:

1. A method, comprising:
measuring, at one or more of a plurality of phasor measurement units (PMUs) connected between a power grid and associated loads, a present power produced by photovoltaic systems deployed downstream from the one or more of the plurality of PMUs,
measuring, at the one or more of the plurality of PMUs, a present demand for power from the associated loads;
generating a power production prediction by the photovoltaic systems for an upcoming time period;
generating a demand prediction for power from the associated loads for the upcoming time period; and
adjusting a tap position on a substation transformer serving the power grid from a generator source to the associated loads based on the power production prediction and the demand prediction indicating a predicted voltage constraint violation in the upcoming time period.

2. The method of claim 1, further comprising, in response to detecting the predicted voltage constraint violation in the upcoming time period:
injecting reactive power into the power grid from one or more PV systems during the upcoming time period via inverters associated with the one or more PV systems.

3. The method of claim 1, wherein an artificial neural network generates the power production prediction and the demand prediction and determines whether the power production prediction and the demand prediction indicate the predicted voltage constraint violation in the upcoming time period.

4. The method of claim 3, wherein the artificial neural network is trained using the Levenberg-Marquardt backpropagation algorithm using historical data for power demand and PV generation.

5. The method of claim 1, wherein each PMU of the plurality of PMUs is installed at a corresponding junction between medium voltage and low voltage in the power grid.

6. The method of claim 1, wherein the substation transformer is installed at a junction between high voltage and medium voltage in the power grid.

7. The method of claim 1, wherein the predicted voltage constraint violation is indicated when a voltage drop or rise greater than 5 percent of a nominal voltage limit is predicted to occur in the upcoming time period.

8. The method of claim 1, wherein the upcoming time period has a duration of one hour, wherein the present power produced and the present demand are measured during an hour prior to the upcoming time period.

9. A method, comprising:
measuring, at one or more of a plurality of phasor measurement units (PMUs) connected between a power grid and associated loads, a present power produced by photovoltaic systems deployed downstream from the one or more of the plurality of PMUs,
measuring, at the one or more of the plurality of PMUs, a present demand for power from the associated loads;
generating a power production prediction by the photovoltaic systems for an upcoming time period;
generating a demand prediction for power from the associated loads for the upcoming time period; and
injecting reactive power into the power grid from one or more PV systems during the upcoming time period via inverters associated with the one or more PV systems based on the power production prediction and the demand prediction indicating a predicted voltage constraint violation in the upcoming time period.

10. The method of claim 9, further comprising, in response to detecting the predicted voltage constraint violation in the upcoming time period:
adjusting a tap position on a substation transformer serving the power grid from a generator source to the associated loads.

11. The method of claim 10, wherein the substation transformer is installed at a junction between high voltage and medium voltage in the power grid.

12. The method of claim 9, wherein an artificial neural network generates the power production prediction and the demand prediction and determines whether the power production prediction and the demand prediction indicate the predicted voltage constraint violation in the upcoming time period.

13. The method of claim 11, wherein the artificial neural network is trained using the Levenberg-Marquardt backpropagation algorithm using historical data for power demand and PV generation.

14. The method of claim 9, wherein each PMU of the plurality of PMUs is installed at a corresponding junction between medium voltage and low voltage in the power grid.

15. The method of claim 9, wherein the predicted voltage constraint violation is indicated when a voltage drop or rise greater than 5 percent of a nominal voltage limit is predicted to occur in the upcoming time period.

16. The method of claim 9, wherein the upcoming time period has a duration of one hour, wherein the present power produced and the present demand are measured during an hour prior to the upcoming time period.

17. A system, comprising:
a processor; and
a memory storing instructions that, when executed by the processor, perform operations including:
measuring, at one or more of a plurality of phasor measurement units (PMUs) connected between a power grid and associated loads, a present power produced by photovoltaic systems deployed downstream from the one or more of the plurality of PMUs,
measuring, at the one or more of the plurality of PMUs, a present demand for power from the associated loads;
generating a power production prediction by the photovoltaic systems for an upcoming time period;
generating a demand prediction for power from the associated loads for the upcoming time period; and
taking a mitigation action based on the power production prediction and the demand prediction indicating a predicted voltage constraint violation in the upcoming time period of one or both of:
injecting reactive power into the power grid from one or more PV systems during the upcoming time period via inverters associated with the one or more PV systems; or
adjusting a tap position on a substation transformer serving the power grid from a generator source to the associated loads.

18. The system of claim 17, wherein an artificial neural network generates the power production prediction and the demand prediction and determines whether the power production prediction and the demand prediction indicate the predicted voltage constraint violation in the upcoming time period, wherein the artificial neural network is trained using the Levenberg-Marquardt backpropagation algorithm using historical data for power demand and PV generation.

19. The system of claim 17, wherein each PMU of the plurality of PMUs is installed at a corresponding junction between medium voltage and low voltage in the power grid and wherein the substation transformer is installed at a junction between high voltage and medium voltage in the power grid.

20. The system of claim 17, wherein the predicted voltage constraint violation is indicated when a voltage drop or rise greater than 5 percent of a nominal voltage limit is predicted to occur in the upcoming time period.
